(19) United States
(12) Patent Application Publication
(10) Pub. No.: US 2020/0001416 A1
(43) Pub. Date: Jan. 2, 2020

(54) MACHINE TOOL

(71) Applicant: OKUMA Corporation, Niwa-gun (JP)

(72) Inventors: Hiroyuki SUGIURA, Niwa-gun (JP); Shoichi MORIMURA, Niwa-gun (JP)

(21) Appl. No.: 16/454,588

(22) Filed: Jun. 27, 2019

(30) Foreign Application Priority Data
Jun. 29, 2018 (JP) 2018-124999

(51) Int. Cl. B23Q 3/155

(52) U.S. Cl. CPC B23Q 3/1554; B23Q 3/15526

(57) ABSTRACT

A machine tool that processes a workpiece with a tool includes a holding device that holds a workpiece or a tool used in processing the workpiece, a first connector attached to the holding device, a transmission line that transmits at least one of fluid, powder, electricity, and light, and including a second connector connectable to the first connector, a storage unit that stores and protects the transmission line, and a transmission line transport mechanism that transports a tip end of the transmission line and switches the transmission line between an expanded state and a recovered state. The transmission line is pulled out from the storage unit and connected to the holding device via the second connector in the expanded state, while being recovered by the storage unit in the recovered state.

### CROSS REFERENCE TO RELATED APPLICATION

The present application claims priority under 35 U.S.C. § 119 to Japanese Patent Application No. 2018-124999 filed on Jun. 29, 2018, the entire content of which is incorporated herein by reference.

### TECHNICAL FIELD

The present disclosure relates to a machine tool that processes a workpiece with a tool.

### BACKGROUND

Machine tools that process a workpiece with tools have been widely recognized. Such machine tools include, for example, a cutting machine for cutting the workpiece with a cutting tool, a grinding machine for grinding the workpiece with a grindstone, and a press machine for pressing the workpiece with a die. For such machine tools, it is necessary to aggregate processing steps to further improve production efficiency, for which an additional device, such as a measurement tool or a processing tool, is desired to be installed additionally to the existing machine tool. Addition of such an additional device enables execution of a measurement step or other processing steps in the machine tool to further enhance production efficiency.

Usually, the additional device is installed in the vicinity of the workpiece or mounted on a moving object capable of moving in the vicinity of the workpiece. The additional device naturally needs a transmission line (e.g., an electric power cable, a tube, or an optical fiber) for transmitting electric power, powder, fluid (e.g., air for activation or hydraulic oil), light, or the like.

### CITATION LIST

PATENT LITERATURE: JP H03-166036 A

### SUMMARY

JP H03-166036 A discloses a machine tool in which a cleaning nozzle can be mounted afterwards on the main spindle of a tool. The cleaning nozzle includes a locking unit provided at its tip end, and the locking unit can be attached to an arbor mounted on the main spindle of the tool. The machine tool includes a moving means that can movably support the cleaning nozzle. When cleaning is necessary, the cleaning nozzle is attached to the arbor.

In the structure of JP H03-16636 A, however, the cleaning nozzle is continuously exposed to the inside of a processing chamber where processing chips or cutting oil are often generated. If a transmission line such as the nozzle is provided in such an exposed manner inside the processing chamber, the transmission line may interfere with the processing chips or the cutting oil to cause degradation or disconnection of the transmission line. Therefore, the transmission line may be disposed in a holding device that holds the workpiece or tool. In this case, however, a design change of the holding device is necessary, possibly causing an increase of cost and labor. In addition, the transmission line disposed in the holding device may limit the number of transmission lines or the thickness of the transmission line.

In view of the above, the present specification discloses a machine tool capable of appropriately providing a transmission line that transmits fluid, powder, electricity, light, or the like without changing the structure of a holding device that holds the workpiece or the tool.

A machine tool disclosed in the present specification includes a holding device that holds a workpiece or a tool used in processing the workpiece, a first connector attached to the holding device, a transmission line that transmits at least one of fluid, powder, electricity, and light, and including a second connector that is connectable to the first connector, a storage unit that stores and protects the transmission line, and a transmission line transport mechanism that transports a tip end of the transmission line and switches the transmission line between an expanded state and a recovered state, in which the transmission line is pulled out from the storage unit and connected to the holding device via the first connector and the second connector in the expanded state, while being recovered by the storage unit in the recovered state. As used herein, the “tool” refers to a tool, such as a cutting tool, a drill, a grindstone, a buffer, a press die, or the like, that applies arbitrary processing to the workpiece.

In this case, an additional device attached to the holding device to additionally process the tool or the workpiece in provided, and the first connector is provided on the additional device, so that the additional device receives at least one of fluid, powder, electricity, and light via the transmission line.

In this case, the transmission line transport mechanism keeps the transmission line in the recovered state during processing of the workpiece with the tool, while keeping the transmission line in the expanded state during additional processing.

The storage unit may include a cord reel that reels the transmission line, and a storage box that stores the transmission line reeled by the cord reel.

The transmission line transport mechanism may include an articulated robot.

The machine tool may include a support mechanism that supports a part of the transmission line in the expanded state.

According to the machine tool of the present disclosure, the transmission line transport mechanism switches the transmission line between the expanded state and the recovered state. When the transmission line is in the expanded state, the transmission line for transmitting fluid, powder, electricity, light, or the like can be provided without changing the structure of the holding device that holds the workpiece or the tool. On the other hand, when the transmission line is in the recovered state, interference between the transmission line and the chip or the like can be prevented, so that the degradation or disconnection of the transmission line can be prevented. In other words, the tool machine disclosed in the present specification can appropriately provide the transmission line for transmitting fluid, powder, electricity, light, or the like without changing the structure of the holding device that holds the workpiece or the tool.

### BRIEF DESCRIPTION OF DRAWINGS

Embodiments of the present disclosure will be described based on the following figures, in which

FIG. 1 is a front view of a machine tool;

FIG. 2 is a cross-sectional view along line A-A of FIG. 1;

FIG. 3 is a front view of the machine tool in an expanded state;

FIG. 4 is a front view of the machine tool during recovery; and

FIG. 5 illustrates how the transmission line is supported by a robot in the machine tool.

### DESCRIPTION OF EMBODIMENTS

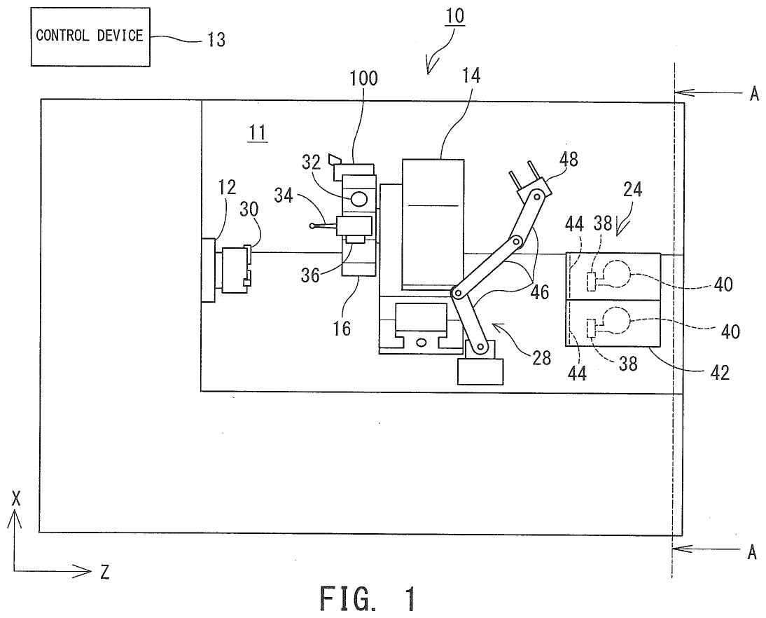

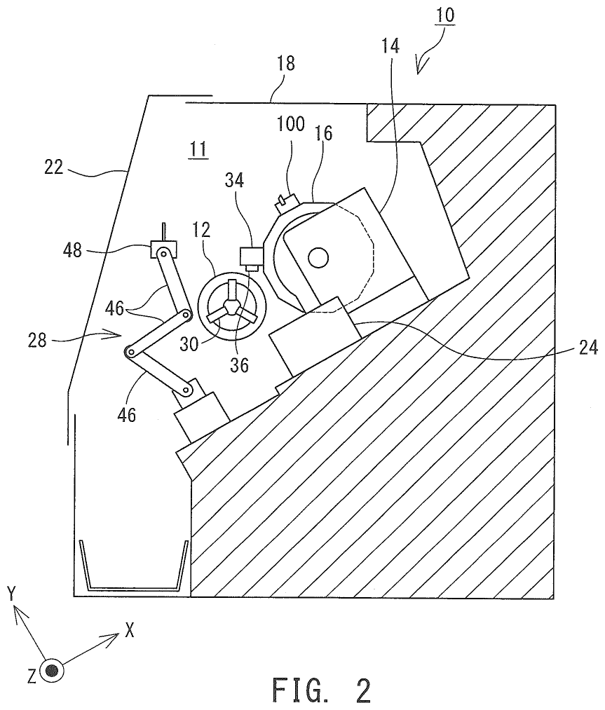

A structure of a machine tool 10 is described below with reference to the accompanying drawings. FIG. 1 is a schematic front view of the machine tool 10. FIG. 2 is a cross-sectional view of FIG. 1 along line A-A. In the following description, it is assumed that the Z-axis extends in a direction parallel to a rotational axis Rw of a workpiece main spindle 12, the X-axis extends in a direction parallel to a moving direction of a tool post 14 perpendicular to Z-axis, and the Y-axis extends in a direction perpendicular to the X-axis and the Z-axis. A positive direction of each axis extends from the workpiece main spindle 12 toward the tool post 14 for the Z- and X-axes and upward from the workpiece main spindle 12 for the Y-axis.

The machine tool 10 is a lathe machine that processes a rotating workpiece (not shown) held on the tool post 14 by bringing a tool 100 to be in contact with the workpiece. Specifically, the machine tool 10 is a turning center controlled by numerical control (NC) and includes a turret 16 that holds a plurality of tools 100. A processing chamber 11 of the machine tool 10 is covered by a cover 18 (not shown in FIG. 1). On the front side of the processing chamber 11, a large opening is formed, which can be opened or closed by a door 22 (not shown in FIG. 1; see FIG. 2). An operator accesses individual parts of the processing chamber 11 through the opening. The door 22 of the opening is closed during processing for safety, environmental concern, or the like.

The machine tool 10 includes a workpiece main spindle device that rotatably holds one end of the workpiece, the tool post 14 that holds the tool 100, and a tailstock (not shown) that supports the other end of the workpiece. The workpiece main spindle device includes a head stock (not shown) with a driving motor or the like stored therein, and the workpiece main spindle 12 attached to the head stock. The workpiece main spindle 12 includes a chuck 30 or a collet that detachably holds the workpiece to allow appropriate exchange of the workpiece being held. The workpiece main spindle 12 and the chuck 30 rotate about a rotation axis of the workpiece extending in a horizontal direction (in the Z-axis direction in FIG. 1).

The tailstock is disposed to face the workpiece main spindle 12 in the Z-axis direction to support the other end of the workpiece held by the workpiece main spindle 12. The tailstock can move in the Z-axis direction to move toward or move away from the workpiece.

The tool post 14 holds a cutting tool, such as one called a tool bit, and functions as a holding device. The tool post 14 is movable in the Z-axis direction; that is, in the direction parallel to the axis of the workpiece. The tool post 14 can also move toward or away from the workpiece in the direction parallel to X-axis; that is, in a radial direction of the workpiece. As can be seen in FIG. 2, X-axis is inclined relative to the horizontal direction and extends upward toward the back from the opening of the processing chamber 11. The turret 16 that can hold the plurality of tools 100 is disposed at the tip end of the tool post 14. The turret 16 has a polygonal shape, when viewed in the Z-axis direction, and is rotatable about an axis parallel to the Z-axis. A plurality of pilot bores 32 are formed on the peripheral surface of the turret 16 to attach a tool holder on the turret 16. The tool holder is fastened with bolts, with a part of the tool holder being inserted into the pilot bores 32. The tools 100 are mounted on the turret 16 via the tool holder. In the present embodiment, an additional device 34 for additionally processing the workpiece is disposed on the turret 16, in addition to the tools 100, as will be described in detail later.

Thus, the tools 100 used in machining the workpiece can be appropriately changed as the turret 16 is rotated. When the tool post 14 is moved in the direction parallel to the Z-axis, the tools 100, which are held on the turret 16, also move in the direction parallel to the Z-axis. The tool post 14 also moves in the direction parallel to the X-axis to allow the tools held on the turret 16 to move in the direction parallel to the X-axis. Moving the tool post 14 in the direction parallel to the X-axis can also change, for example, a cutting amount of the workpiece by the tools 100. In other words, the tools 100 attached to the tool post 14 are movable within a plane parallel to an X-Z plane.

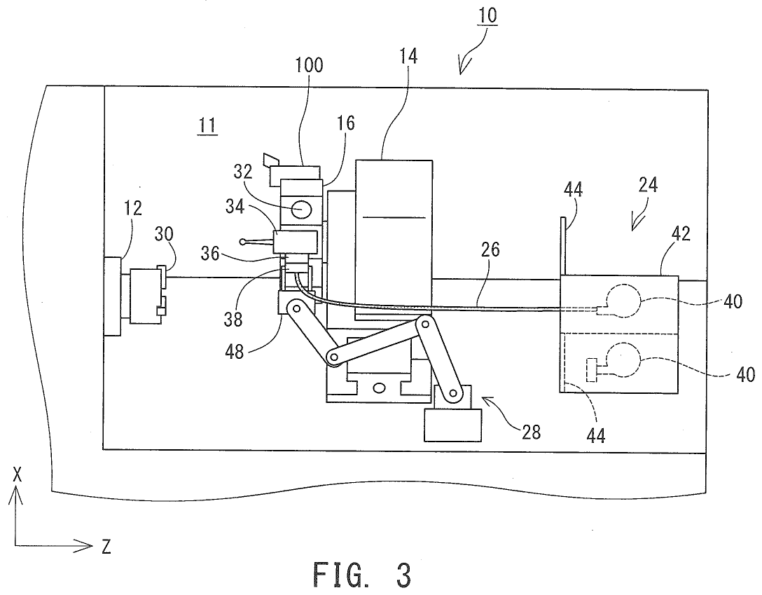

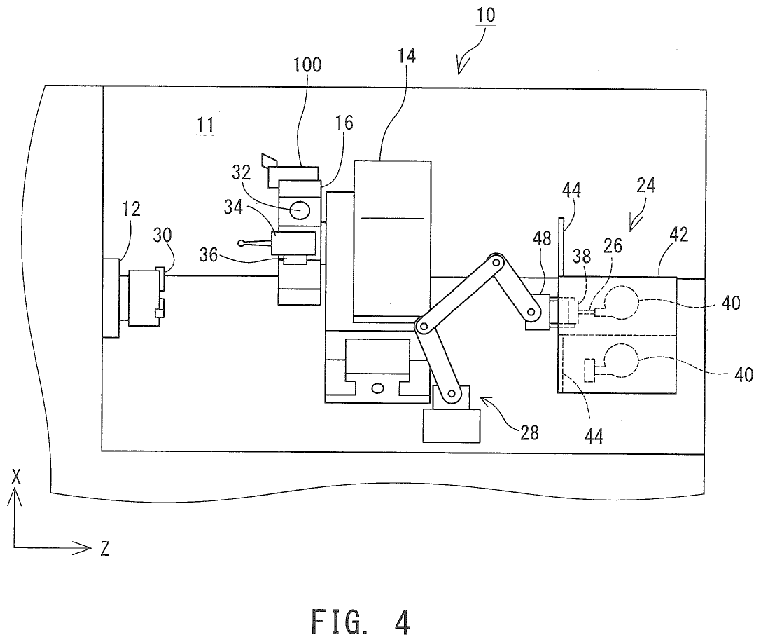

The processing chamber 11 also include a storage unit 24 and an in-machine robot 28. The storage unit 24 reels and recovers a transmission line 26 (not seen in FIG. 1 and FIG. 2) which is connected to the additional device 34. The in-machine robot 28 transports the transmission line 26 and functions as a transmission line transport mechanism. Before describing the storage unit 24 and the in-machine root 28, the additional device 34 and the transmission line 26 are described with reference to FIG. 3 and FIG. 4. FIG. 3 is a front view of the machine tool 10 when the transmission line 26 is expanded, and FIG. 4 is a front view of the machine tool when the transmission line 26 is recovered.

The additional device 34 applies additional processing, such as measuring, grinding, additional machining by laser, quenching, engraving, ultracold cooling with liquid nitrogen or the like, or disposing of swarf generated from a high pressure coolant. To distinguish the processing of the additional processing carried out by the additional device 34, the processing carried out by the tools 100 held on the holding device (or tool post 14 in the present embodiment) is referred to as main processing.

The additional device 34 is not used while the workpiece is subjected to lathe turning with the tools 100 (i.e., during execution of the main processing), and is used before or after the main processing. In the present embodiment, the plurality of pilot bores 32 are formed in the turret 16, and the additional device 34 is attached to one of these pilot bores 32.

The additional device 34 operates by using electric power, powder, fluid, light, or the like transmitted through the transmission line 26. In a case where the additional device 34 is provided as a measurement device or machining device driven by electricity, the transmission line 26 may be an electric cable (e.g., an electric cable, a coaxial cable, a flat cable, or the like) which transmits electric power or electric signals. In a case where the additional device 34 is provided as a machining device driven by air pressure, the transmission line 26 may be a tube which transmits air. In a case where the additional device 34 is provided as a three-dimensional printer that injects powder such as metal powder or the like for sintering, the transmission line 26 may be a tube that feeds the powder. In a case where the transmission line 26 sends and receives light signals to and from the additional device 34 or laser processing is performed, the transmission line 26 may be provided as an optical fiber. One or more transmission lines 26 may be connected to one additional device 34, so that two or more transmission lines 26 of different kinds (e.g., the electricity cable and the optical fiber cable) may be connected to one additional device 34. Further, two or more additional devices 34 (e.g., the measurement device and the machining device) may be attached to one holding device (or the tool post 14 in the present embodiment).

The additional device 34 and the transmission line 26 include a first connector 36 and a second connector 38, respectively, for relaying the connection between the additional device 34 and the transmission line 26. The first connector 36 and the second connector 38 need to be detachable, but their shape is not particularly limited. Therefore, publicly known connectors or couplers may be used as the first and second connectors 36 and 38. For example, the first and second connectors 36 and 38 may be communication connectors (e.g., DS connectors or LAN terminals), computer connectors (e.g., USB connectors or DIN connectors), power supply connectors, coaxial connectors (e.g., SMP connectors or SMB connectors), round connectors, square connectors, optical connectors (e.g., MT connectors or FC connectors), fluid couplers (e.g., couplers for breakaway coupling or non-spill coupling), or hybrid connectors integrating electric terminals and the fluid coupling.

Basically, the first and second connectors 36 and 38 are connected by inserting one connector into the other. Some locking mechanism may be provided on the first and second connectors 36 and 38 to prevent unintentional disconnection. For example, such locking mechanism may be locked via engagement or by biasing force of a spring, and unlocked by pressing a lock pin, twisting a connector, or pulling a part of the connector against the biasing force. Switching between locking and unlocking may be achieved by the movement of the in-machine robot 28 which will be described later. Alternatively, an actuator driven by air may be installed on at least one of the first and second connectors 36 and 38 to switch between locking and unlocking by supplying air to the actuator.

The first connector 36 attached to the additional device 34 is disposed with its connection port exposed to the inside of the processing chamber 11 after the second connector 38 is removed. This may cause the swarf or the cutting oil to enter the connection port of the first connector 36. To avoid this, a connector cover (not shown) covering the connection port may be provided on the first connector 36. The connector cover recedes automatically so as not to interfere with the connection of the second connector 38, and covers the connection port automatically when the second connector 38 is pulled out. In this respect, the connector cover itself may be made of an elastically deformable material whose elastic deformation and elastic recovery force allows the connector cover to move toward or away from the connection port. Alternatively, the connector cover may include a spring or an actuator to allow the connector cover to be connected to or disconnected from the connection port.

The storage unit 24 stores the above-mentioned transmission line 26 and is disposed at a position not interfering with the movement of the tool post 14. The storage unit 24 includes a cord reel 40 that reels the transmission line 26, and a storage box 42 storing the cord reel 40. The cord reel 40 reels the transmission line 26, and includes at least a bobbin for winding the transmission line 26. The cord reel 40 may further include a spring that biases the bobbin in a winding direction, or a motor or the like that rotates the bobbin.

The storage box 42 stores the cord reel 40 and the transmission line 26 wound by the cord reel 40. The storage box 42 includes an opening for pulling out the transmission line 26 and a shutter 44 for opening and closing the opening. The transmission line 26 with the second connector 38 can be stored completely in the storage box 42. When the transmission line 26 is completely stored, the opening is closed by the shutter 44. The shutter 44 may be automatically opened and closed by electric power, hydraulic power, or the like, or by the in-machine robot 28 which will be described later. In any case, covering the opening with the shutter 44 protects the transmission line 26 with the second connector 38 from the swarf or the cutting oil. The transmission line 26 has its other end connected to a supply source (not shown) of electricity, fluid, powder, or light, directly or via another relay member. The number of the transmission lines 26 stored in one storage box 42 is not particularly limited, and one or more transmission lines 26 may be stored.

In the following, it is assumed that a state in which the transmission line 26 is completely stored in the storage unit 24 as illustrated in FIG. 1 is referred to as a “recovered state,” while a state in which the transmission line 26 is pulled out from the storage unit 24 so that the second connector 38 is connected to the first connector 36, as illustrated in FIG. 3, is referred to as an “expanded state.”

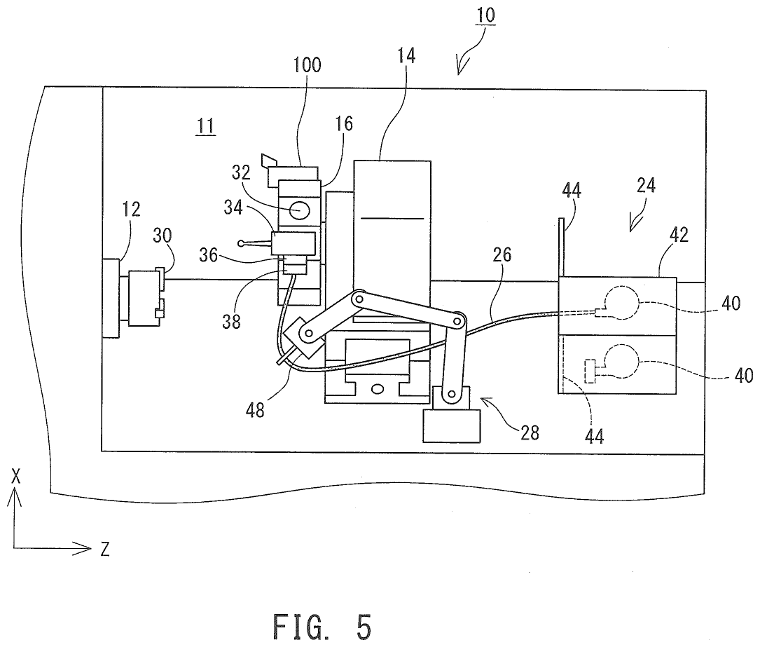

The in-machine robot 28 is an articulated robot that functions as a transmission line transport mechanism which transports the transmission line 26 and switches the state of the transmission line between the recovered state and the expanded state. In the present embodiment, the in-machine robot 28 is installed on the floor surface of the processing chamber 11. However, the in-machine robot 28 needs to transport the transmission line, and the installing position or the structure of the in-machine robot 28 may be changed appropriately. For example, the in-machine 28 may be installed on the wall surface, the tool post 14, the workpiece main spindle 12, the tailstock, or the like in the processing chamber 11. The movement range of the in-machine robot 28 increases if the in-machine robot 28 is installed on a moving object such as the tool post 14 or the tailstock. The in-machine robot 28 includes a plurality of arms (three arms are illustrated in the present embodiment) 46 connected via articulating joints with an end effector 48 provided on the tip end of the arm. Any kind of the end effector 48 that can hold the second connector 38 may be used. In the present embodiment, the end effector 48 is a hand mechanism that grips and holds the object. The end effector 48 (hand mechanism) not only grips the second connector 38 but can also grip the transmission line 26, as illustrated in FIG. 5. Although one end effector 48 is illustrated in the present embodiment, the in-machine robot 28 may include more than one end effector 48.

A control device 13 controls activation of each part of the machine tool 10 according to the instruction from the operator. The control device 13 includes, for example, a CPU executing various calculations, and a memory storing various control programs and control parameters. The control device 13 also has a communication function and can send and receive various kinds of data, such as NC program data or the like, to and from other devices. The control device 13 may include, for example, a numerical control device that calculates, as needed, the positions of the tools 100 or the workpiece. The control device 13 may be a single device or may be formed by combining a plurality of calculation devices.

The control device 13 controls the movement of, for example, the workpiece main spindle 12, the tool post 14, or the tailstock, when turning the workpiece with the tools 100. Further, the control device 13 of the present embodiment controls the activation of the in-machine robot 28, as needed, to switch the transmission line 26 between the expanded state and the recovered state. In the following, the switching between the expanded state and the recovered state is described.

As described above, the additional device 34 that executes additional processing on the workpiece is provided in addition to the tools 100 with which the workpiece is subjected to lathe turning in the present embodiment. The additional device 34 executes additional processing on the workpiece while the main processing, in which the workpiece is processed with the tools 100, is not performed. If the transmission line 26 is exposed to the inside of the processing chamber 11, the swarf or the cutting oil may hit the transmission line 26 to possibly degrade or break the transmission line 26.

Therefore, the control device 13 confirms the state of the transmission line 26 before starting the main processing. To confirm, for example, a sensor that detects the connection state with the second connector 38 may be provided on the first connector 36, or a sensor that detects the open or close state of the shutter 44 may be provided on the storage box 42. If it is confirmed that the transmission line 26 is in the expanded state, the control device 13 instructs the in-machine robot 28 to recover the transmission line 26 into the storage box 42. Upon receiving the instruction, the in-machine robot 28 moves its end effector 48 (hand device) to the second connector 38 connected to the first connector 36 and grips the second connector 38 with the end effector 48. Then, the in-machine robot 28 drives the lock mechanism of the connector to be released and removes the second connector 38 from the first connector 36.

When the second connector 38 is removed from the first connector 36, the in-machine robot 28 moves the second connector 38 to the storage box 42, as illustrated in FIG. 4. At this time, the transmission line 26 is gradually wound by the power of the spring, the motor, or the like disposed on the cord reel 40. When the transmission line 26 is completely wound at last, and the second connector 38 is stored in the storage box 42, the in-machine robot 28 releases the grip of the end effector 48 gripping the second connector 38. Finally, when the shutter 44 is closed automatically or by the manipulation of the in-machine robot 48, the transmission line 26 and the second connector 38 are in the recovered state (the state illustrated in FIG. 1) in which the transmission line 26 and the second connector 38 are stored completely in the storage box 42.

In the recovered state, the degradation of the transmission line 26 can be prevented almost completely, even when the main processing is executed and the swarf and the cutting oil are scattered in the processing chamber 11. To prevent the entry of the swarf and the cutting oil to the connection port of the first connector 36 during the main processing, the connection port of the first connector 36 may be covered automatically or by the operation of the in-machine robot 28 before the main processing starts.

Before or after the main processing starts, the additional device 34 may execute additional processing on the workpiece. In this case, the control device 13 confirms the state of the transmission line 26 before the additional processing starts. As a result of confirmation, if the transmission line 26 is in the recovered state, the control device 13 instructs the in-machine robot 28 to change the transmission line 26 to the expanded state. Upon receipt of the instruction, the in-machine robot 28 moves its end effector 48 (hand device) to the storage box 42, and causes the end effector 48 to grip the second connector 38 in the storage box 42. Naturally, before the gripping, the shutter 44 of the storage box 42 is released automatically or by the operation of the in-machine robot 28. After gripping the second connector 38, the in-machine robot 28 moves the second connector 38 to the first connector 36. The transmission line 26 is pulled by the in-machine robot 28 and pulled out against the winding force of the cord reel 40. When the in-machine robot 28 finally attaches the second connector 38 to the first connector 36, as illustrated in FIG. 3, the transmission line 26 is pulled out to achieve the expanded state in which the additional device 34 can operate.

As is apparent from the description heretofore, the present embodiment sets the expanded state in which the transmission line 26 is pulled out when the transmission line 26 is necessary or the additional device 34 is used, while setting the recovered state in which the transmission line 26 is recovered in the storage unit 24 during the execution of the main processing. Thus, the state is switched between the expanded state and the recovered state to reliably provide the transmission line appropriately to transmit fluid, powder, electricity, light, or the like without changing the structure of the holding device that holds the tool post 14 or the tools 100.

Specifically, if the transmission line 26 is kept connected to the additional device 34 to provide the transmission line for transmitting fluid, powder, electricity, light, or the like, the transmission line 26 is kept exposed to the inside of the processing chamber 11. This may cause degradation or disconnection of the transmission line 26 due to the swarf or the cutting oil scattered during the execution of the main processing, and the transmission line 26 cannot be provided appropriately.

It is possible to extend the transmission line 26 through the inside of the tool post 14, instead of exposing outward. This can effectively prevent the degradation or the like of the transmission line 26, but extending the transmission line 26 inside the tool post 14 requires a substantial design change and causes an increase of cost and labor. Further, if the transmission line 26 extends through the inside of the tool post 14, the number and the thickness of the transmission lines 26 are easily limited.

On the other hand, in the present embodiment, the transmission line 26 is not buried in the holding device, such as the tool post 14, so that the design change of the tool post 14 is not necessary. In addition, the transmission line 26 is pulled out only when needed in the present embodiment, so the degradation or disconnection of the transmission line 26 can be effectively prevented. Thus, the transmission line for transmitting fluid, powder, electricity, light, or the like can be provided reliably and appropriately without changing the design or structure of the holding device such as the tool post 14.

When the additional device 34 executes the additional processing, the control device 13 can move the tool post 14, as needed, to change the position and posture of the additional device 34. At this time, the in-machine robot 28 may partially support the expanded transmission line 26 to prevent entanglement or interference of the transmission line 26 connected to the additional device 34 (and the tool post 14). In other words, as illustrated in FIG. 5, after the transmission line 26 is changed to the expanded state, the in-machine robot 28 may grip the middle portion of the transmission line 26 with the end effector 48 (hand mechanism) provided at the tip end of the in-machine robot 28. Thus, the in-machine robot 28 functions as the transmission line support mechanism for supporting the transmission line 26, as well as the transmission line transport mechanism for transporting the transmission line 26. The control device 13 drives the in-machine robot 28 to follow the tool post 14 with the first connector 36 provided thereon, in order to maintain an appropriate tension of the transmission line 26. This effectively prevents the entanglement or disconnection of the transmission line 26 due to excessive loosening or tightening.

While certain structures have been described, these structures have been presented by way of example only. All structures need to include the transmission line transport mechanism that transports the transmission line 26 and switches between the expanded state and the recovered state, and other components of the structure may be changed appropriately. For example, in the above embodiment the in-machine robot 28 or the articulated robot is used as the transmission line transport mechanism, but other mechanisms may be used. A gantry loader, for example, may be provided in the vicinity of the ceiling of the processing chamber 11 and used as the transmission line transport mechanism. It is desired in this case that the positions of the first connector 36 and the storage unit 24 are arranged so as to allow attachment and removal of the first and second connectors 36 and 38 with simple actions, because the gantry loader has a low degree of freedom of movement.

Further, in the description the additional device 34 has been attached to the tool post 14, or more specifically, on the turret 16, but the additional device 34 may alternatively be attached to a different device; that is, a holding device that holds the workpiece or the tools 100 with which the workpiece is processed. For example, the additional device 34 may be disposed on the workpiece main spindle 12 that holds the workpiece. In a case where the machine tool 10 includes a tool main spindle that rotatably holds the tools 100, the additional device 34 may be attached to the tool main spindle. In any case, the holding device that holds the workpiece or the tools can approach the workpiece or the tools 100, and by attaching the additional device 34 to such a holding device, the additional device 34 can more easily access the workpiece or the tools 100. Accordingly, the additional processing can be applied to the workpiece or the tools 100. Alternatively, the additional device 34 may not be added if the additional processing to the workpiece or the tools 100 is available only with the transmission line 26. For example, when the additional processing is to apply a special fluid transmitted through the transmission line 26 to the workpiece or the tools 100, the additional device 34 may not be necessary and the holding device may only include the first connector 36 to which the transmission line 26 is connected.

1. A machine tool that processes a workpiece with a tool, comprising:
a holding device that holds a workpiece or a tool used in processing the workpiece;
a first connector attached to the holding device;
a transmission line that transmits at least one of fluid, powder, electricity, and light, and including a second connector connectable to the first connector;
a storage unit that stores and protects the transmission line; and
a transmission line transport mechanism that transports a tip end of the transmission line and switches the transmission line between an expanded state and a recovered state, wherein
the transmission line is pulled out from the storage unit and connected to the holding device via the first connector and the second connector in the expanded state, while being recovered by the storage unit in the recovered state.

2. The machine tool according to claim 1, further comprising:
an additional device attached to the holding device to additionally process the tool or the workpiece, wherein
the first connector is provided on the additional device, and
the additional device receives at least one of fluid, powder, electricity, and light via the transmission line.

3. The machine tool according to claim 2, wherein
the transmission line transport mechanism keeps the transmission line in the recovered state during processing of the workpiece with the tool, while keeping the transmission line in the expanded state during additional processing.

4. The machine tool according to claim 1, wherein
the storage unit includes
a cord reel that reels the transmission line, and
a storage box that stores the transmission line reeled by the cord reel.

5. The machine tool according to claim 1, wherein
the transmission line transport mechanism includes an articulated robot.

6. The machine tool according to claim 1, further comprising:
a support mechanism that supports a part of the transmission line in the expanded state.

7. The machine tool according to claim 6,
the transmission line transport mechanism also functions as the support mechanism.
